(19) United States
(12) Patent Application Publication
(10) Pub. No.: US 2020/0262145 A1
(43) Pub. Date: Aug. 20, 2020

(54) THREE-DIMENSIONAL OBJECT MANUFACTURING SYSTEM AND THREE-DIMENSIONAL OBJECT MANUFACTURING PROGRAM

(71) Applicant: MIMAKI ENGINEERING CO., LTD., Nagano (JP)

(72) Inventors: Kenji Harayama, Nagano (JP); Takeaki Kazaana, Nagano (JP)

(21) Appl. No.: 16/793,271

(22) Filed: Feb. 18, 2020

(30) Foreign Application Priority Data
Feb. 19, 2019 (JP) 2019-027244

(51) Int. Cl. B29C 64/209; B29C 64/245; B29C 64/393

(52) U.S. Cl. CPC B29C 64/209; B33Y 30/00; B29C 64/393; B29C 64/245

(57) ABSTRACT

A 3D printer for manufacturing a three-dimensional object including a target shaped object to be a target and a support portion for supporting the target shaped object at the time of shaping of the target shaped object with an ink including a color ink for forming a color layer for realizing the color of the outer appearance of the target shaped object and a non-color ink that is not the color ink for forming at least one of the target shaped object excluding the color layer and the support portion fills at least one of the interior of the target shaped object and the interior of the support portion that is not the color layer preferentially with the ink with closer expiration date among the plurality of color inks.

### CROSS REFERENCE TO RELATED APPLICATIONS

This application claims the priority benefit of Japanese Patent Application No. 2019-027244, filed on Feb. 19, 2019. The entirety of the above-mentioned patent application is hereby incorporated by reference herein and made a part of this specification.

### TECHNICAL FIELD

The present disclosure relates to a three-dimensional object manufacturing system and a three-dimensional object manufacturing program for manufacturing a three-dimensional object with ink.

### DESCRIPTION OF THE BACKGROUND ART

As a conventional three-dimensional object manufacturing system, a three-dimensional object manufacturing system in which, at the time of manufacturing a three-dimensional object including a target shaped object, which is the target, and a support portion for supporting the target shaped object when shaping the target shaped object through an inkjet head method, at least one of an interior of the target shaped object and an interior of the support portion is filled with color ink for forming a color layer to realize the color of an outer appearance of the target shaped object (see e.g., Japanese Unexamined Patent Publication No. 2016-26915), is known.

Here, in the manufacturing of the three-dimensional object, white ink (hereinafter referred to as “white ink”) for forming the interior of the target shaped object, transparent ink (hereinafter referred to as “clear ink”) for forming the interior of the target shaped object, and an ink for forming a support portion (hereinafter referred to as “support ink”) may be used other than the color ink.

### SUMMARY

The thickness of the color layer of the target shaped object is usually very thin. Thus, the amount of color ink used to form the color layer of the target shaped object is extremely small as compared with the amount of white ink, clear ink, and support ink when a layer (hereinafter referred to as an “interior layer”) formed of color ink is not provided inside the target shaped object or the support portion. Therefore, when the interior layer is not provided inside the target shaped object or the support portion, at least a part of the color ink stored in a cartridge that stores ink to be supplied to an inkjet head has a high possibility of being discarded due to expiration.

Furthermore, conventionally, there is a possibility that ink discarded due to expiration may occur other than the color ink.

Furthermore, conventionally, there exists a user's demand for efficiently consuming ink from a viewpoint other than the viewpoint of expiration date, such as a demand for manufacturing a three-dimensional object using low-cost ink.

Therefore, the present disclosure provides a three-dimensional object manufacturing system and a three-dimensional object manufacturing program that can efficiently consume ink while preventing the outer appearance of a target shaped object from changing.

A three-dimensional object manufacturing system of the present disclosure relates to a three-dimensional object manufacturing system for manufacturing a three-dimensional object with a plurality of inks, in which the three-dimensional object includes a target shaped object to be a target, and the three-dimensional object manufacturing system manufactures the three-dimensional object by forming a part of an interior of the three-dimensional object by replacing with an ink different from an originally scheduled ink so as to be the same as an outer appearance of the target shaped object when the three-dimensional object is manufactured by forming the entire three-dimensional object with the originally scheduled ink.

According to such a configuration, the three-dimensional object manufacturing system of the present disclosure manufactures the three-dimensional object by forming a part of an interior of the three-dimensional object by replacing with an ink different from an originally scheduled ink so as to be the same as the outer appearance of the target shaped object when the three-dimensional object is manufactured by forming the entire three-dimensional object with the originally scheduled ink, and thus the ink can be efficiently consumed while preventing the outer appearance of the target shaped object from changing.

In the three-dimensional object manufacturing system of the present disclosure, the plurality of inks may include a coloring ink for forming a colored layer on a surface of the target shaped object, and an inner ink filled to an inner layer on an inner side of the colored layer of the target shaped object, and the three-dimensional object manufacturing system may form a portion that does not affect a color of the colored layer when observed from an outer side of the target shaped object in the inner layer by replacing with the coloring ink different from the originally scheduled inner ink.

According to such a configuration, the three-dimensional object manufacturing system of the present disclosure forms a portion in the inner layer of the target shaped object, that does not affect a color of the colored layer when observed from an outer side of the target shaped object, by replacing with the coloring ink different from the originally scheduled inner ink, and thus the coloring ink can be efficiently consumed while preventing the color of the outer appearance of the target shaped object from changing.

In the three-dimensional object manufacturing system of the present disclosure, a part of the interior of the three-dimensional object may be formed by replacing with the ink whose expiration date is earlier than the originally scheduled ink.

According to such a configuration, the three-dimensional object manufacturing system according to the present disclosure forms a part of the interior of the three-dimensional object by replacing with the ink whose expiration date is earlier than the originally scheduled ink, and thus the possibility of discarding the ink due to expiration can be reduced.

In the three-dimensional object manufacturing system of the present disclosure, a part of the interior of the three-dimensional object may be formed by replacing with the ink that is lower in price than the originally scheduled ink.

According to such a configuration, the three-dimensional object manufacturing system of the present disclosure forms a part of the interior of the three-dimensional object by replacing with an ink of lower price than the originally scheduled ink, and thus the manufacturing cost of the three-dimensional object can be reduced.

In the three-dimensional object manufacturing system of the present disclosure, when the ink that is insufficient in amount if the entire interior of the three-dimensional object is formed with the originally scheduled ink exists, a part of the interior of the three-dimensional object may be formed not with the ink that becomes insufficient in amount when the interior of the three-dimensional object is entirely formed with the originally scheduled ink but by replacing with an ink that remains when the entire three-dimensional object is formed with the originally scheduled ink.

According to such a configuration, when there exists an ink that is insufficient in amount if the interior of the three-dimensional object is entirely formed with an originally scheduled ink, the three-dimensional object manufacturing system of the present disclosure forms a part of the interior of the three-dimensional object not with an ink that becomes insufficient in amount if the interior of the three-dimensional object is entirely formed with the originally scheduled ink but with an ink that remains if the entire three-dimensional object is formed with the originally scheduled ink, and thus the possibility of discontinuing the manufacturing of the three-dimensional object due to insufficiency of ink can be reduced.

In the three-dimensional object manufacturing system of the present disclosure, the three-dimensional object includes a support portion for supporting the target shaped object at the time of shaping of the target shaped object as required, the ink includes a coloring ink for forming a colored layer for realizing a color of the outer appearance of the target shaped object, and a non-coloring ink that is not the coloring ink for forming at least one of the target shaped object excluding the colored layer and the support portion, the three-dimensional object manufacturing system includes an inkjet head that ejects the ink, and an ejection controller that controls ejection of the ink by the inkjet head, and the ejection controller fills at least one of the interior of the target shaped object and the interior of the support portion that is not the colored layer preferentially with the ink with closer expiration date among the plurality of coloring inks.

According to such a configuration, the three-dimensional object manufacturing system of the present disclosure fills at least one of the interior of the target shaped object and the interior of the support portion preferentially with the ink with closer expiration date among the plurality of coloring inks, and thus the possibility of discarding ink due to expiration can be reduced.

In the three-dimensional object manufacturing system of the present disclosure, the ejection controller may fill the coloring ink to at least one of the interior of the target shaped object and the interior of the support portion that is not the colored layer while ensuring a necessary coloring ink amount that is an amount of coloring ink necessary for forming the colored layer.

According to such a configuration, in the three-dimensional object manufacturing system of the present disclosure, at least one of the interior of the target shaped object and the interior of the support portion is filled with the coloring ink while ensuring the amount of the coloring ink necessary for realizing the color of the outer appearance of the target shaped object, and thus the possibility of appropriately realizing the color of the outer appearance of the target shaped object even if at least one of the interior of the target shaped object and the interior of the support portion is filled with the coloring ink can be enhanced.

A three-dimensional object manufacturing system of the present disclosure relates to a three-dimensional object manufacturing system for manufacturing a three-dimensional object with ink, in which the three-dimensional object includes a target shaped object to be a target, the three-dimensional object includes a support portion for supporting the target shaped object at the time of shaping of the target shaped object as required, the ink includes a coloring ink for forming a colored layer for realizing a color of an outer appearance of the target shaped object, and a non-coloring ink that is not the coloring ink for forming at least one of the target shaped object excluding the colored layer and the support portion, the three-dimensional object manufacturing system includes an inkjet head that ejects the ink, and an ejection controller that controls ejection of the ink by the inkjet head, and the ejection controller fills at least one of the interior of the target shaped object and the interior of the support portion that is not the colored layer with the coloring ink while ensuring a necessary coloring ink amount which is an amount of the coloring ink necessary for forming the colored layer.

According to such a configuration, in the three-dimensional object manufacturing system of the present disclosure, at least one of the interior of the target shaped object and the interior of the support portion is filled with the coloring ink while ensuring the amount of the coloring ink necessary for realizing the color of the outer appearance of the target shaped object, and thus the possibility of appropriately realizing the color of the outer appearance of the target shaped object even if at least one of the interior of the target shaped object and the interior of the support portion is filled with the coloring ink can be enhanced.

In the three-dimensional object manufacturing system of the present disclosure, when it is apparent before the start of the shaping of the three-dimensional object that the amount of non-coloring ink is insufficient to form at least one of the target shaped object excluding the colored layer and the support portion with only the non-coloring ink, the ejection controller may start the shaping of the three-dimensional object when the insufficient amount is less than or equal to a remaining amount obtained by removing the necessary coloring ink amount from the amount of the coloring ink held by the three-dimensional object manufacturing system, and may not start the shaping of the three-dimensional object when the insufficient amount exceeds the remaining amount.

According to such a configuration, when it is apparent before the start of the shaping of the three-dimensional object that the non-coloring ink is insufficient in amount to form at least one of the target shaped object excluding the colored layer and the support portion with only the non-coloring ink, the three-dimensional object manufacturing system of the present disclosure does not start the shaping of the three-dimensional object when the insufficient amount exceeds the remaining amount obtained by removing the amount of coloring ink necessary for realizing the color of the outer appearance of the target shaped object from the amount of coloring ink held by the three-dimensional object manufacturing system, and thus the possibility of appropriately realizing the color of the outer appearance of the target shaped object even if at least one of the interior of the target shaped object and the interior of the support portion is filled with the coloring ink can be enhanced.

In the three-dimensional object manufacturing system of the present disclosure, when it becomes apparent during the shaping of the three-dimensional object that the amount of non-coloring ink is insufficient to form at least one of the target shaped object excluding the colored layer and the support portion with only the non-coloring ink, the ejection controller may fill at least one of the interior of the target shaped object and the interior of the support portion that is not the colored layer with the coloring ink.

According to such a configuration, when it becomes apparent during the shaping of the three-dimensional object that the amount of non-coloring ink is insufficient to form at least one of the target shaped object excluding the colored layer and the support portion with only the non-coloring ink, the three-dimensional object manufacturing system of the present disclosure fills at least one of the interior of the target shaped object and the interior of the support portion with the coloring ink, and thus the possibility of completing the three-dimensional object can be enhanced.

A three-dimensional object manufacturing program of the present disclosure relates to a three-dimensional object manufacturing program for manufacturing a three-dimensional object with a plurality of inks, in which the three-dimensional object includes a target shaped object to be a target, and the three-dimensional object manufacturing program causes a computer to realize the manufacturing of the three-dimensional object by forming a part of an interior of the three-dimensional object by replacing with an ink different from an originally scheduled ink so as to be the same as an outer appearance of the target shaped object when the three-dimensional object is manufactured by forming the entire three-dimensional object with the originally scheduled ink.

According to such a configuration, the computer for executing the three-dimensional object manufacturing program of the present disclosure manufactures the three-dimensional object by forming a part of an interior of the three-dimensional object by replacing with an ink different from an originally scheduled ink so as to be the same as the outer appearance of the target shaped object when the three-dimensional object is manufactured by forming the entire three-dimensional object with the originally scheduled ink, and thus the ink can be efficiently consumed while preventing the outer appearance of the target shaped object from changing.

The three-dimensional object manufacturing system and the three-dimensional object manufacturing program of the present disclosure can efficiently consume ink while preventing the outer appearance of the target shaped object from being changed.

### BRIEF DESCRIPTION OF THE DRAWINGS

FIG. 1 is a schematic front view of a part of a 3D printer according to one embodiment of the present disclosure.

FIG. 2 is a schematic side view of a part of the 3D printer shown in FIG. 1.

FIG. 3 is a block diagram of the 3D printer shown in FIG. 1.

FIG. 4 is a front cross-sectional view of an example of a three-dimensional object manufactured by the 3D printer shown in FIG. 1.

FIG. 5 is a flowchart showing a part of the operation of the 3D printer shown in FIG. 3 when starting the shaping of the three-dimensional object.

FIG. 6 is a flowchart subsequent to the flowchart shown in FIG. 5.

FIG. 7 is a flowchart of a part of the operation of the 3D printer shown in FIG. 3 when determining whether or not there is a need to change the size and shape of the interior layer during the shaping of the three-dimensional object.

FIG. 8 is a flowchart subsequent to the flowchart shown in FIG. 7.

FIG. 9 is a flowchart of the operation of the 3D printer shown in FIG. 3 when determining the color ink for shaping the interior layer.

### DETAILED DESCRIPTION OF EMBODIMENTS

Hereinafter, an embodiment of the present disclosure will be described with reference to the drawings.

First, a configuration of a 3D printer serving as a three-dimensional object manufacturing system according to one embodiment of the present disclosure will be described.

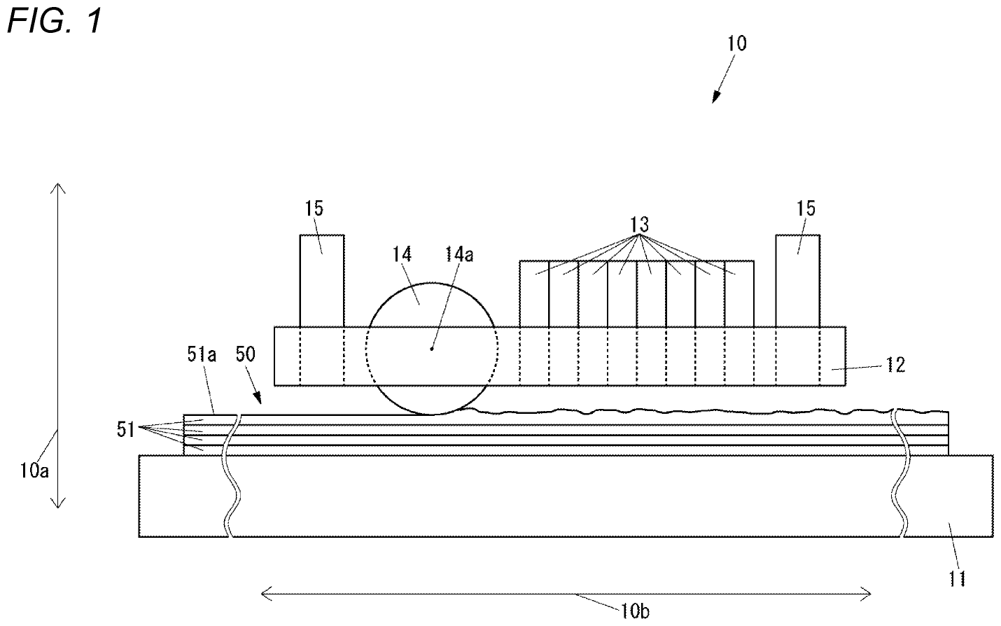

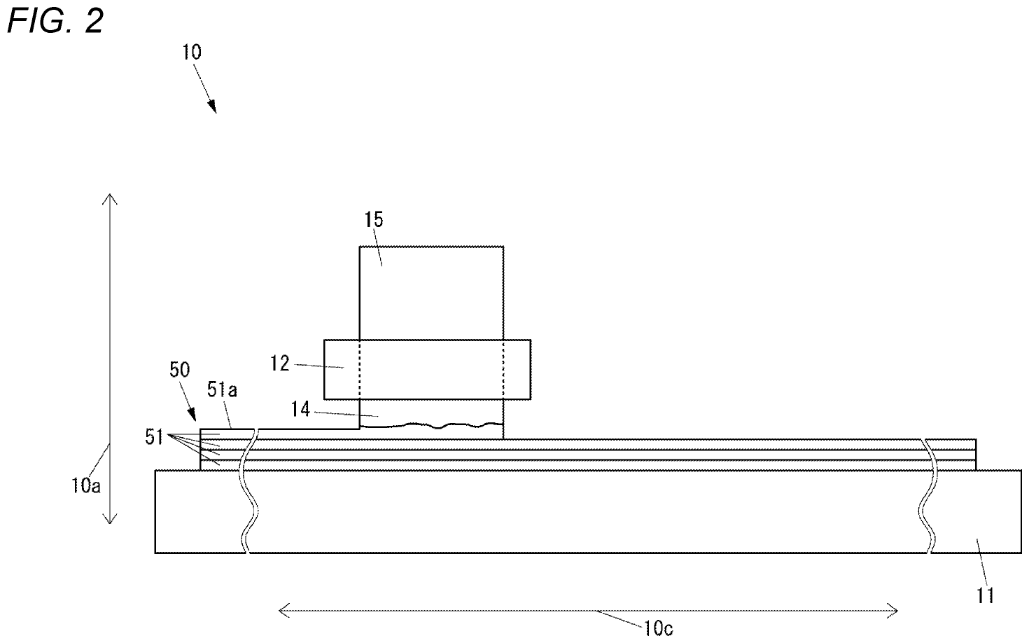

FIG. 1 is a schematic front view of a part of a 3D printer 10 according to the present embodiment. FIG. 2 is a schematic side view of a part of the 3D printer 10.

As shown in FIGS. 1 and 2, the 3D printer 10 includes a shaping table 11 serving as a table of a three-dimensional object 50 when the three-dimensional object 50 is manufactured, a carriage 12 disposed on an upper side of the shaping table 11 in a vertical direction indicated by an arrow 10a and being movable in a left-right direction indicated by an arrow 10b orthogonal to the vertical direction, a plurality of inkjet heads 13 that eject an ultraviolet-curable ink toward a lower side in the vertical direction to form an ink layer 51, a flattening roller 14 serving as a flattening mechanism that flattens a surface 51a of the ink layer 51 by removing a part on the surface 51a side of the ink layer 51 formed by the inkjet heads 13 and adjusts a thickness of the ink layer 51 to a specific thickness, and a plurality of ultraviolet irradiation units 15 that irradiate ultraviolet light toward the ink layer 51 flattened by the flattening roller 14. The 3D printer 10 is an apparatus that layers and stacks the ink layers 51 formed by ink in the vertical direction to ultimately manufacture the entire three-dimensional object 50.

The shaping table 11 is movable in the vertical direction with respect to the carriage 12, and is also movable with respect to the carriage 12 in a front-back direction indicated by an arrow 10c orthogonal to both the vertical direction and the left-right direction.

The inkjet heads 13, the flattening roller 14, and the ultraviolet irradiation unit 15 are mounted on the carriage 12.

The inkjet head 13 ejects ink from a plurality of nozzles (not shown) arranged in the front-back direction. The 3D printer 10 may, for example, include an inkjet head that ejects cyan ink (hereinafter referred to as “cyan ink”) serving as color ink, an inkjet head that ejects magenta ink (hereinafter referred to as “magenta ink”) serving as color ink, an inkjet head that ejects yellow ink (hereinafter referred to as “yellow ink”) serving as color ink, an inkjet head that ejects black ink (hereinafter referred to as “black ink”) serving as color ink, an inkjet head that ejects white ink (hereinafter referred to as “white ink”) serving as ink that is not color ink (hereinafter referred to as “non-color ink”), an inkjet head that ejects transparent ink (hereinafter referred to as “clear ink”) serving as a non-color ink, and an inkjet head that ejects ink (hereinafter referred to as “support ink”) for forming a support portion, to be described later, at the inkjet head 13. The support ink is ink that can be easily removed after curing, such as ink that can be removed with a specific liquid such as water after curing.

The flattening roller 14 is extended in the front-back direction, and is mounted on the carriage 12 in a rotatable state about a center axis 14a extending in the front-back direction.

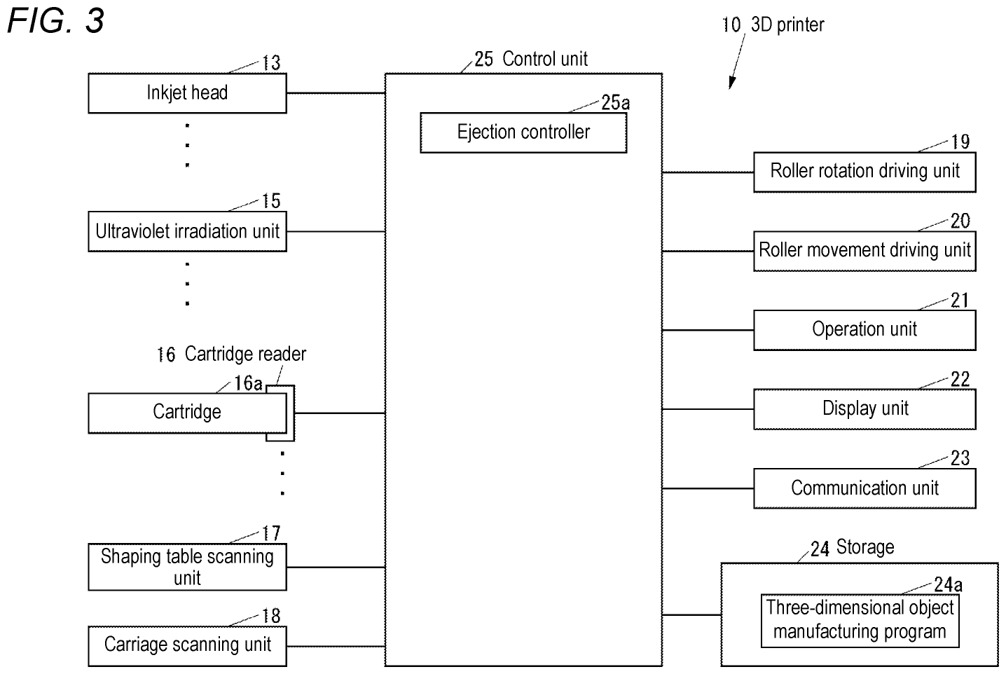

FIG. 3 is a block diagram of the 3D printer 10.

As shown in FIG. 3, the 3D printer 10 includes the plurality of inkjet head 13, the plurality of ultraviolet irradiation units 15, a plurality of cartridge readers 16 that acquire various types of information from each of the plurality of cartridges 16a storing ink to be supplied to the inkjet head 13, a shaping table scanning unit 17 that moves the shaping table 11 (see FIG. 1), a carriage scanning unit 18 that moves the carriage 12 (see FIG. 1), a roller rotation driving unit 19 that rotates the flattening roller 14 about the center axis 14a (see FIG. 1) of the flattening roller 14 (see FIG. 1), a roller movement driving unit 20 that moves the flattening roller 14 in the vertical direction, an operation unit 21 which is an input device such as, for example, a keyboard, a mouse, and the like to which various operations are input, a display unit 22 which is a display device such as a liquid crystal display (LCD) that displays various types of information, a communication unit 23 which is a communication device that communicates with an external device via the network or directly in a wired or wireless manner without interposing the network, a storage 24 which is a nonvolatile storage device such as a semiconductor memory, a hard disk drive (HDD), and the like that stores various types of information, a control unit 25 that controls the entire 3D printer 10.

The 3D printer 10 may have, for example, a cartridge that stores cyan ink, a cartridge that stores magenta ink, a cartridge that stores yellow ink, a cartridge that stores black ink, a cartridge that stores white ink, a cartridge that stores clear ink, and a cartridge that stores support ink attached as the cartridge 16a.

The cartridge reader 16 can acquire the expiration date of the ink stored in the cartridge 16a from a storage medium such as an integrated circuit (IC) chip attached to the cartridge 16a. Furthermore, the cartridge reader 16 can acquire the amount of ink stored in the cartridge 16a from the cartridge 16a.

A shaping table scanning unit 17 can move the shaping table 11 in the vertical direction and in the front-back direction.

The carriage scanning unit 18 can move the carriage 12 in the left-right direction.

The roller movement driving unit 20 lowers the flattening roller 14 when the ink layer 51 is flattened by the flattening roller 14, and raises the flattening roller 14 when the ink layer 51 is not flattened by the flattening roller 14.

The storage 24 stores a three-dimensional object manufacturing program 24a for manufacturing the three-dimensional object 50. The three-dimensional object manufacturing program 24a may be installed, for example, in the 3D printer 10 at the time of manufacturing the 3D printer 10, may be additionally installed in the 3D printer 10 from an external storage medium such as a USB (Universal Serial Bus) memory, or may be additionally installed in the 3D printer 10 from the network.

The control unit 25 includes, for example, a central processing unit (CPU), a read only memory (ROM) that stores programs and various data, and a random access memory (RAM) used as a work area of the CPU of the control unit 25. The CPU of the control unit 25 executes the program stored in the ROM of the control unit 25 or the storage 24. That is, the control unit 25 constitutes a computer.

The control unit 25 realizes an ejection controller 25a that controls the ejection of ink by the inkjet head 13 by executing the three-dimensional object manufacturing program 24a.

Next, the three-dimensional object 50 manufactured by the 3D printer 10 will be described.

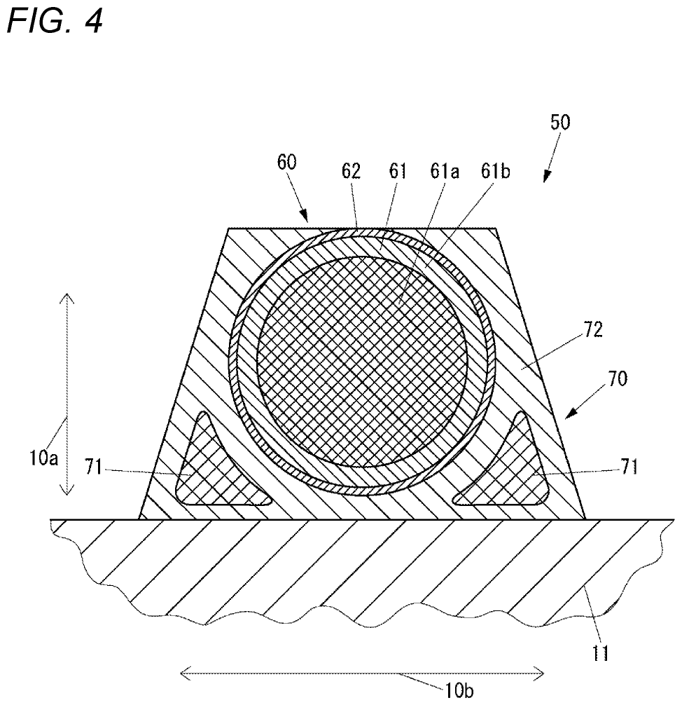

FIG. 4 is a front cross-sectional view of an example of the three-dimensional object 50.

A three-dimensional object 50 shown in FIG. 4 includes a target shaped object 60 which is a target, and a support portion 70 for supporting the target shaped object 60 at the time of shaping the target shaped object 60. The support portion 70 is provided as necessary. That is, the support portion 70 does not need to be provided if the target shaped object 60 does not need to be supported at the time of shaping the target shaped object 60.

The target shaped object 60 includes a model layer 61 that realizes the shape of the target shaped object 60, and a color layer 62 serving as a colored layer that is provided outside the model layer 61 to realize the color of the outer appearance of the target shaped object 60.

The model layer 61 constitutes an inner layer on the inner side of the color layer 62 of the target shaped object 60. The model layer 61 is formed by white ink or is formed by both white ink and clear ink, and also plays a role of reflecting the light from the outside that has passed through the color layer 62 and returning it again to the outside for visualization. However, the model layer 61 may be interiorly provided with a layer (hereinafter, referred to as “interior layer”) 61a formed of color ink. In a case where the model layer 61 includes the interior layer 61a, a portion of the model layer 61 other than the interior layer 61a is hereinafter referred to as an exterior layer 61b. The thickness of the exterior layer 61b is preferably an appropriate thickness such as, for example, 2 mm to greater than or equal to 3 mm to prevent the color of the interior layer 61a from being transmitted to the outside of the target shaped object 60, and to have the color of the outer appearance of the target shaped object 60 appropriately realized. The ejection controller 25a may be instructed with the thickness of the exterior layer 61b through the operation unit 21 or the communication unit 23.

The color layer 62 is formed of color ink. That is, the color ink constitutes a coloring ink for forming the color layer 62 serving as a colored layer on the surface of the target shaped object 60. The white ink and the clear ink are non-coloring inks that are not coloring inks, and constitute the inner ink filled in the model layer 61 serving as the inner layer on the inner side of the color layer 62 in the target shaped object 60. The thickness of the color layer 62 is, for example, 150 μm to 300 μm.

The support portion 70 is formed of a support ink which is a non-coloring ink. However, the support portion 70 may interiorly include an interior layer 71 formed of color ink. In a case where the support portion 70 includes the interior layer 71, a portion other than the interior layer 71 in the support portion 70 is hereinafter referred to as an exterior layer 72. Note that the interior layer 71 may exist at the boundary of the support portion 70 as long as it does not contact the target shaped object 60. The thickness of the exterior layer 72 is preferably an appropriate thickness that allows the support portion 70 to be appropriately removed from the target shaped object 60. The ejection controller 25a may be instructed with the thickness of the exterior layer 72 through the operation unit 21 or the communication unit 23.

Next, the operation of the 3D printer 10 will be described.

First, the operation of the 3D printer 10 when starting the shaping of the three-dimensional object 50 will be described.

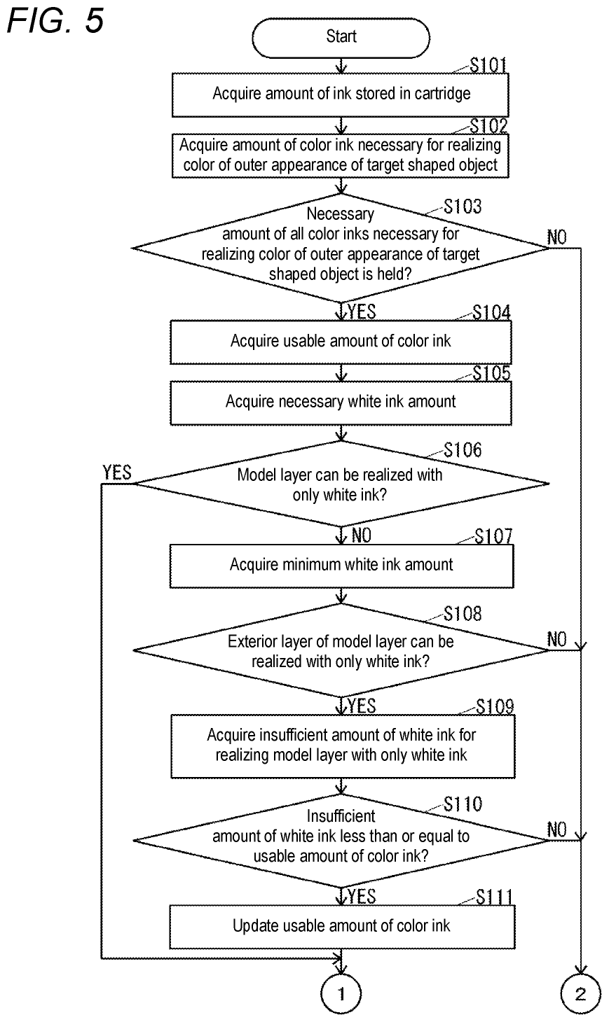

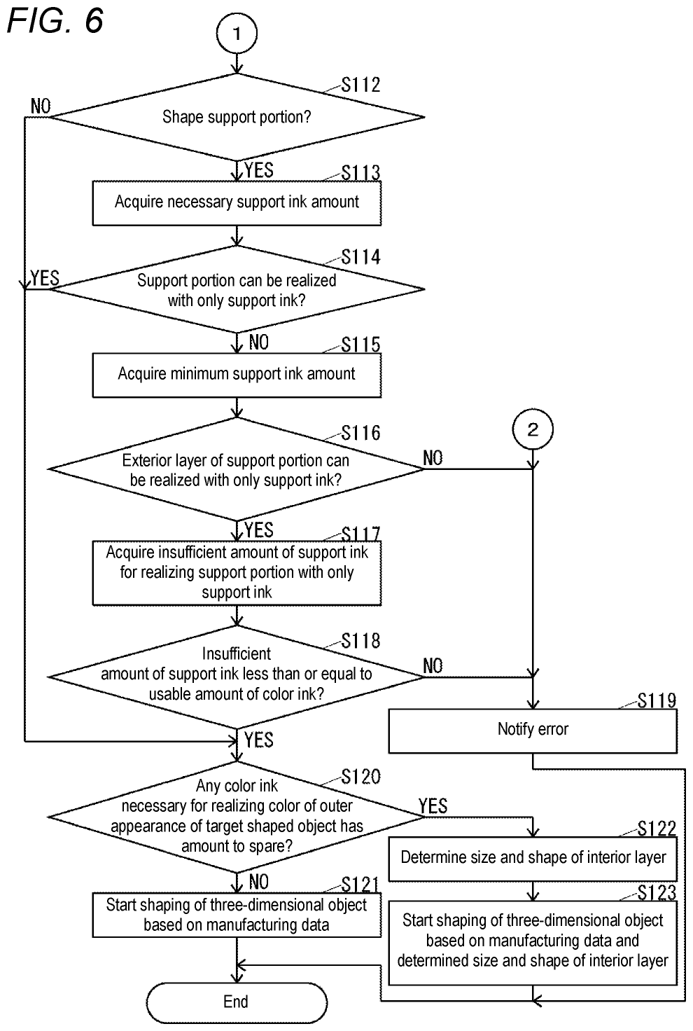

FIGS. 5 and 6 are flowcharts of the operation of the 3D printer 10 when starting the shaping of the three-dimensional object 50.

When the control unit 25 receives the manufacturing data of the three-dimensional object 50 through the communication unit 23, the control unit 25 executes the operations shown in FIGS. 5 and 6.

As shown in FIGS. 5 and 6, the ejection controller 25a acquires the amount of ink stored in the cartridge 16a through the cartridge reader 16 (S101).

Next, the ejection controller 25a acquires the amount of color ink necessary for realizing the color of the outer appearance of the target shaped object 60, that is, the amount of color ink necessary for realizing the color layer 62 based on the manufacturing data (S102).

Next, the ejection controller 25a determines whether or not it has a necessary amount for all the color inks necessary for realizing the color of the outer appearance of the target shaped object 60 (S103). Here, the ejection controller 25a determines that it has a necessary amount when the amount acquired in S101 is greater than or equal to the amount acquired in S102 with respect to the color ink necessary for realizing the color of the outer appearance of the target shaped object 60. On the other hand, the ejection controller 25a determines that it does not have the necessary amount when the amount acquired in S101 is less than the amount acquired in S102 with respect to the color ink necessary for realizing the color of the outer appearance of the target shaped object 60.

When determining in S103 that it has the necessary amount for all the color inks necessary for realizing the color of the outer appearance of the target shaped object 60, the ejection controller 25a acquires the remaining amount obtained by excluding the total amount of color ink acquired in S102 (hereinafter referred to as “necessary color ink amount” in the description of the operation shown in FIGS. 5 and 6) from the total amount of all the color inks acquired in S101 as a usable amount of color ink (S104).

Next, the ejection controller 25a acquires the amount of white ink (hereinafter referred to as “necessary white ink amount”) necessary for realizing the model layer 61 based on the manufacturing data when realizing the model layer 61 with only the white ink (white ink and clear ink depending on the manufacturing data; the same applies hereinafter) (S105).

Next, the ejection controller 25a determines whether or not the model layer 61 can be realized with only white ink based on the amount of white ink acquired in S101 and the necessary white ink amount acquired in S105 (S106). Here, when the amount of white ink acquired in S101 is greater than or equal to the necessary white ink amount acquired in S105, the ejection controller 25a determines that the model layer 61 can be realized with only white ink. On the other hand, when the amount of white ink acquired in S101 is less than the necessary white ink amount acquired in S105, the ejection controller 25a determines that the model layer 61 cannot be realized with only white ink.

When determining in S106 that the model layer 61 cannot be realized with only white ink, the ejection controller 25a acquires the amount of white ink (hereinafter referred to as “minimum white ink amount”) necessary for realizing the exterior layer 61b when realizing the exterior layer 61b with only white ink based on the manufacturing data (S107).

Next, the ejection controller 25a determines whether or not the exterior layer 61b can be realized with only white ink based on the amount of white ink acquired in S101 and the minimum white ink amount acquired in S107 (S108). Here, when the amount of white ink acquired in S101 is greater than or equal to the minimum white ink amount acquired in S107, the ejection controller 25a determines that the exterior layer 61b can be realized with only white ink. On the other hand, when the amount of white ink acquired in S101 is less than the minimum white ink amount acquired in S107, the ejection controller 25a determines that the exterior layer 61b cannot be realized with only white ink.

When determining in S108 that the exterior layer 61b can be realized with only white ink, the ejection controller 25a acquires an insufficient amount of white ink for realizing the model layer 61 with only white ink by subtracting the amount of white ink acquired in S101 from the necessary white ink amount acquired in S105 (S109).

Next, the ejection controller 25a determines whether or not the insufficient amount of white ink acquired in S109 is less than or equal to the usable amount of color ink (S110).

When determining in S110 that the insufficient amount of white ink is less than or equal to the usable amount of color ink, the ejection controller 25a updates the usable amount of color ink by subtracting the insufficient amount of white ink acquired in S109 from the usable amount of color ink (S111).

When determining in S106 that the model layer 61 can be realized with only white ink or executing the process of S111, the ejection controller 25a determines whether or not to shape the support portion 70 based on the manufacturing data (S112).

When determining in S112 to shape the support portion 70, the ejection controller 25a acquires the amount of support ink (hereinafter referred to as “necessary support ink amount”) necessary for realizing the support portion 70 when realizing the support portion 70 with only support ink based on the manufacturing data (S113).

Next, the ejection controller 25a determines whether or not the support portion 70 can be realized with only the support ink, based on the amount of support ink acquired in S101 and the necessary support ink amount acquired in S113 (S114). Here, when the amount of support ink acquired in S101 is greater than or equal to the necessary support ink amount acquired in S113, the ejection controller 25a determines that the support portion 70 can be realized with only the support ink. On the other hand, when the amount of support ink acquired in S101 is less than the necessary support ink amount acquired in S113, the ejection controller 25a determines that the support portion 70 cannot be realized with only the support ink.

When determining in S114 that the support portion 70 cannot be realized with only the support ink, the ejection controller 25a acquires an amount of support ink necessary for realizing the exterior layer 72 when the exterior layer 72 is realized with only the support ink (hereinafter referred to as “minimum support ink amount”) based on the manufacturing data (S115).

Next, the ejection controller 25a determines whether or not the exterior layer 72 can be realized with only the support ink based on the amount of support ink acquired in S101 and the minimum support ink amount acquired in S115 (S116). Here, when the amount of support ink acquired in S101 is greater than or equal to the minimum support ink amount acquired in S115, the ejection controller 25a determines that the exterior layer 72 can be realized with only the support ink. On the other hand, when the amount of support ink acquired in S101 is less than the minimum support ink amount acquired in S115, the ejection controller 25a determines that the exterior layer 72 cannot be realized with only the support ink.

When determining in S116 that the exterior layer 72 can be realized with only the support ink, the ejection controller 25a acquires an insufficient amount of support ink for realizing the support portion 70 with only the support ink by subtracting the amount of support ink acquired in S101 from the necessary support ink amount acquired in S113 (S117).

Next, the ejection controller 25a determines whether or not the insufficient amount of support ink acquired in S117 is less than or equal to the usable amount of color ink (S118).

When determining in S103 that it does not have the necessary amount for at least one color ink necessary for realizing the color of the outer appearance of the target shaped object 60, determining in S108 that the exterior layer 61b cannot be realized with only white ink, determining in S110 that the insufficient amount of white ink is not less than or equal to the usable amount of color ink, determining in S116 that the exterior layer 72 cannot be realized with only the support ink, or determining in S118 that the insufficient amount of support ink is not less than or equal to the usable amount of color ink, the ejection controller 25a notifies of an error through at least one of the display unit 22 and the communication unit 23 (S119), and does not start the shaping of the three-dimensional object 50.

When determining in S112 that the support portion 70 is not shaped, determining in S114 that the support portion 70 can be realized with only the support ink, or determining in S118 that the insufficient amount of support ink is less than or equal to the usable amount of color ink, the ejection controller 25a determines whether or not any of the color inks necessary for realizing the color of the outer appearance of the target shaped object 60 has some amount to spare (S120). Here, the ejection controller 25a determines that there is an amount to spare when the amount acquired in S101 exceeds the amount acquired in S102 with respect to the color ink necessary for realizing the color of the outer appearance of the target shaped object 60. On the other hand, the ejection controller 25a determines that there is no amount to spare when the amount acquired in S101 is the same as the amount acquired in S102 with respect to the color ink necessary to realize the color of the outer appearance of the target shaped object 60.

When determining in S120 that all the color inks necessary for realizing the color of the outer appearance of the target shaped object 60 do not have an amount to spare, the ejection controller 25a starts to shape the three-dimensional object 50 based on the manufacturing data (S121).

When determining in S120 that any of the color inks necessary for realizing the color of the outer appearance of the target shaped object 60 has an amount to spare, the ejection controller 25a determines the sizes and shapes of the interior layer 61a and the interior layer 71 (S122). Here, the ejection controller 25a determines the total size of the interior layer 61a and the interior layer 71 as the size and shape to be shaped by the color ink of an amount less than or equal to the remaining amount obtained by excluding the necessary color ink amount from the total amount of all color inks acquired in S101. Furthermore, the ejection controller 25a determines the size and shape of the interior layer 61a while ensuring the minimum size and shape of the exterior layer 61b. Similarly, the ejection controller 25a determines the size and shape of the interior layer 71 while ensuring the minimum size and shape of the exterior layer 72. Furthermore, when determining in S106 that the model layer 61 cannot be realized with only the white ink, the ejection controller 25a determines the size and shape of the interior layer 61a as the size and shape to be shaped by the color ink of an amount greater than or equal to an insufficient amount acquired in S109. Similarly, when determining in S114 that the support portion 70 cannot be realized with only the support ink, the ejection controller 25a determines the size and shape of the interior layer 71 as the size and shape to be shaped by the color ink of an amount greater than or equal to the insufficient amount acquired in S117.

After the process of S122, the ejection controller 25a starts to shape the three-dimensional object 50 based on the manufacturing data and the sizes and shapes of the interior layer 61a and the interior layer 71 determined in S122 (S123).

The ejection controller 25a terminates the operation shown in FIGS. 5 and 6 after the process of S119, S121, or S123.

Next, the operation of the 3D printer 10 when determining whether or not there is a need to change the size and shape of the interior layer 61a or the interior layer 71 during the shaping of the three-dimensional object 50 will be described.

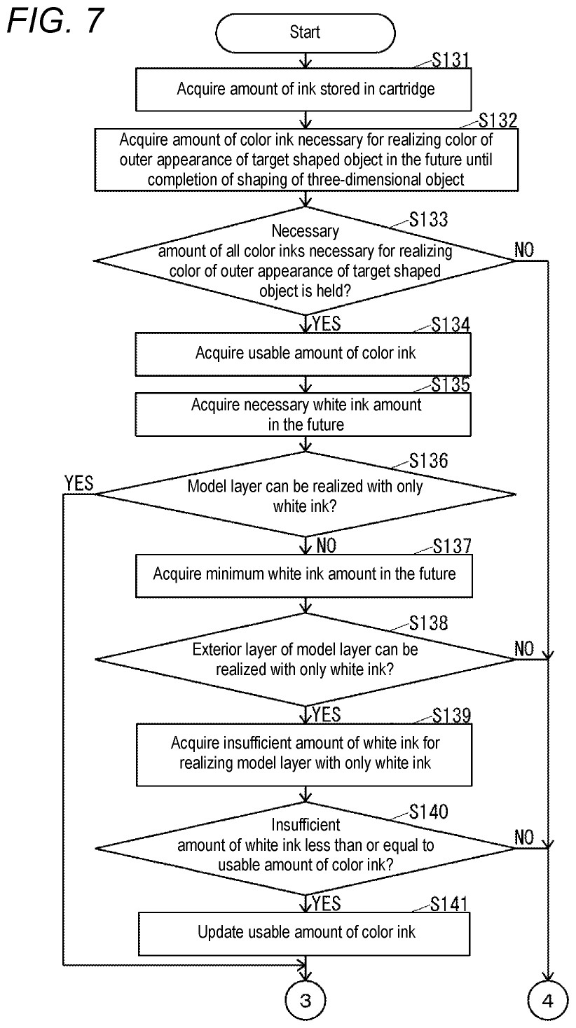

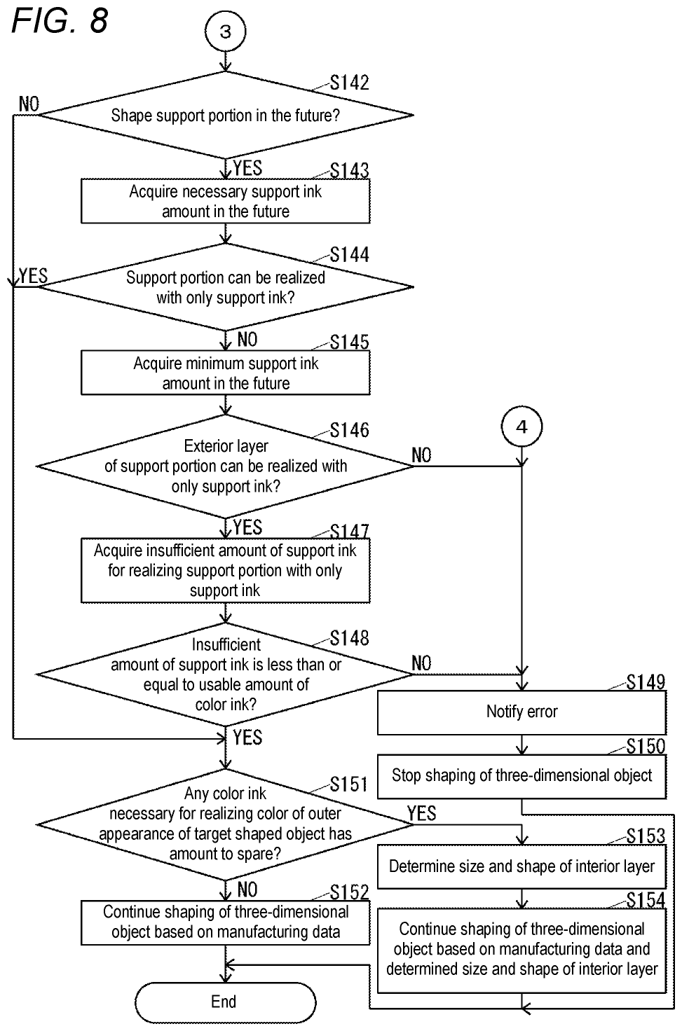

FIGS. 7 and 8 are flowcharts of the operation of the 3D printer 10 when determining that there is a need to change the size and shape of the interior layer 61a or the interior layer 71 during the shaping of the three-dimensional object 50.

The control unit 25 repeatedly executes the operations shown in FIGS. 7 and 8 during the shaping of the three-dimensional object 50.

As shown in FIGS. 7 and 8, the ejection controller 25a acquires the amount of ink stored in the cartridge 16a through the cartridge reader 16 (S131).

Next, the ejection controller 25a acquires the amount of color ink necessary for realizing the color of the outer appearance of the target shaped object 60, that is, the amount of color ink necessary for realizing the color layer 62 in the future until the completion of the shaping of the three-dimensional object 50 based on the manufacturing data (S132).

Next, the ejection controller 25a determines whether or not it has a necessary amount for all the color inks necessary for realizing the color of the outer appearance of the target shaped object 60 (S133). Here, the ejection controller 25a determines that it has a necessary amount when the amount acquired in S131 is greater than or equal to the amount acquired in S132 with respect to the color ink necessary for realizing the color of the outer appearance of the target shaped object 60. On the other hand, the ejection controller 25a determines that it does not have the necessary amount when the amount acquired in S131 is less than the amount acquired in S132 with respect to the color ink necessary for realizing the color of the outer appearance of the target shaped object 60.

When determining in S133 that it has the necessary amount for all the color inks necessary for realizing the color of the outer appearance of the target shaped object 60, the ejection controller 25a acquires the remaining amount obtained by excluding the total amount of color ink acquired in S132 (hereinafter referred to as “necessary color ink amount” in the description of the operation shown in FIGS. 7 and 8) from the total amount of all the color inks acquired in S131 as a usable amount of color ink (S134).

Next, the ejection controller 25a acquires the necessary white ink amount in the future until the completion of the shaping of the three-dimensional object 50 based on the manufacturing data (S135).

Next, the ejection controller 25a determines whether or not the model layer 61 can be realized with only white ink based on the amount of white ink acquired in S131 and the necessary white ink amount acquired in S135 (S136). Here, when the amount of white ink acquired in S131 is greater than or equal to the necessary white ink amount acquired in S135, the ejection controller 25a determines that the model layer 61 can be realized with only white ink. On the other hand, when the amount of white ink acquired in S131 is less than the necessary white ink amount acquired in S135, the ejection controller 25a determines that the model layer 61 cannot be realized with only white ink.

When determining in S136 that the model layer 61 cannot be realized with only white ink, the ejection controller 25a acquires the minimum white ink amount in the future until the completion of the shaping of the three-dimensional object 50 based on the manufacturing data (S137).

Next, the ejection controller 25a determines whether or not the exterior layer 61b can be realized with only white ink based on the amount of white ink acquired in S131 and the minimum white ink amount acquired in S137 (S138). Here, when the amount of white ink acquired in S131 is greater than or equal to the minimum white ink amount acquired in S137, the ejection controller 25a determines that the exterior layer 61b can be realized with only white ink. On the other hand, when the amount of white ink acquired in S131 is less than the minimum white ink amount acquired in S137, the ejection controller 25a determines that the exterior layer 61b cannot be realized with only white ink.

When determining in S138 that the exterior layer 61b can be realized with only white ink, the ejection controller 25a acquires an insufficient amount of white ink for realizing the model layer 61 with only white ink by subtracting the amount of white ink acquired in S131 from the necessary white ink amount acquired in S135 (S139).

Next, the ejection controller 25a determines whether or not the insufficient amount of white ink acquired in S139 is less than or equal to the usable amount of color ink (S140).

When determining in S140 that the insufficient amount of white ink is less than or equal to the usable amount of color ink, the ejection controller 25a updates the usable amount of color ink by subtracting the insufficient amount of white ink acquired in S139 from the usable amount of color ink (S141).

When determining in S136 that the model layer 61 can be realized with only white ink or executing the process of S141, the ejection controller 25a determines whether or not to shape the support portion 70 in the future until the completion of the shaping of the three-dimensional object 50 based on the manufacturing data (S142).

When determining in S142 to shape the support portion 70, the ejection controller 25a acquires the amount of support ink necessary in the future until the completion of the shaping of the three-dimensional object 50 based on the manufacturing data (S143).

Next, the ejection controller 25a determines whether or not the support portion 70 can be realized with only the support ink, based on the amount of support ink acquired in S131 and the necessary support ink amount acquired in S143 (S144). Here, when the amount of support ink acquired in S131 is greater than or equal to the necessary support ink amount acquired in S143, the ejection controller 25a determines that the support portion 70 can be realized with only the support ink. On the other hand, when the amount of support ink acquired in S131 is less than the necessary support ink amount acquired in S143, the ejection controller 25a determines that the support portion 70 cannot be realized with only the support ink.

When determining in S144 that the support portion 70 cannot be realized with only the support ink, the ejection controller 25a acquires the minimum support ink amount in the future until the completion of the shaping of the three-dimensional object 50 based on the manufacturing data (S145).

Next, the ejection controller 25a determines whether or not the exterior layer 72 can be realized with only the support ink based on the amount of support ink acquired in S131 and the minimum support ink amount acquired in S145 (S146). Here, when the amount of support ink acquired in S131 is greater than or equal to the minimum support ink amount acquired in S145, the ejection controller 25a determines that the exterior layer 72 can be realized with only the support ink. On the other hand, when the amount of support ink acquired in S131 is less than the minimum support ink amount acquired in S145, the ejection controller 25a determines that the exterior layer 72 cannot be realized with only the support ink.

When determining in S146 that the exterior layer 72 can be realized with only the support ink, the ejection controller 25a acquires an insufficient amount of support ink for realizing the support portion 70 with only the support ink by subtracting the amount of support ink acquired in S131 from the necessary support ink amount acquired in S143 (S147).

Next, the ejection controller 25a determines whether or not the insufficient amount of support ink acquired in S147 is less than or equal to the usable amount of color ink (S148).

When determining in S133 that it does not have the necessary amount for at least one color ink necessary for realizing the color of the outer appearance of the target shaped object 60, determining in S138 that the exterior layer 61b cannot be realized with only white ink, determining in S140 that the insufficient amount of white ink is not less than or equal to the usable amount of color ink, determining in S146 that the exterior layer 72 cannot be realized with only the support ink, or determining in S148 that the insufficient amount of support ink is not less than or equal to the usable amount of color ink, the ejection controller 25a notifies of an error through at least one of the display unit 22 and the communication unit 23 (S149), and stops the shaping of the three-dimensional object 50 (S150).

When determining in S142 that the support portion 70 is not shaped, determining in S144 that the support portion 70 can be realized with only the support ink, or determining in S148 that the insufficient amount of support ink is less than or equal to the usable amount of color ink, the ejection controller 25a determines whether or not any of the color inks necessary for realizing the color of the outer appearance of the target shaped object 60 has some amount to spare (S151). Here, the ejection controller 25a determines that there is an amount to spare when the amount acquired in S131 exceeds the amount acquired in S132 with respect to the color ink necessary for realizing the color of the outer appearance of the target shaped object 60. On the other hand, the ejection controller 25a determines that there is no amount to spare when the amount acquired in S131 is the same as the amount acquired in S132 with respect to the color ink necessary to realize the color of the outer appearance of the target shaped object 60.

When determining in S151 that all the color inks necessary for realizing the color of the outer appearance of the target shaped object 60 do not have an amount to spare, the ejection controller 25a continues to shape the three-dimensional object 50 based on the manufacturing data (S152).

When determining in S151 that any of the color inks necessary for realizing the color of the outer appearance of the target shaped object 60 has an amount to spare, the ejection controller 25a determines the sizes and shapes of the interior layer 61a and the interior layer 71 (S153). Here, the ejection controller 25a determines the total size of the interior layer 61a and the interior layer 71 as the size and shape to be shaped by the color ink of an amount less than or equal to the remaining amount obtained by excluding the necessary color ink amount from the total amount of all color inks acquired in S131. Furthermore, the ejection controller 25a determines the size and shape of the interior layer 61a while ensuring the minimum size and shape of the exterior layer 61b. Similarly, the ejection controller 25a determines the size and shape of the interior layer 71 while ensuring the minimum size and shape of the exterior layer 72. Furthermore, when determining in S136 that the model layer 61 cannot be realized with only the white ink, the ejection controller 25a determines the size and shape of the interior layer 61a as the size and shape to be shaped by the color ink of an amount greater than or equal to an insufficient amount acquired in S139. Similarly, when determining in S144 that the support portion 70 cannot be realized with only the support ink, the ejection controller 25a determines the size and shape of the interior layer 71 as the size and shape to be shaped by the color ink of an amount greater than or equal to the insufficient amount acquired in S147. Note that when the size and shape of the interior layer 61a can be maintained to the size and shape of before the start of the operation shown in FIGS. 7 and 8 of this time, the ejection controller 25a may maintain the size and shape of the interior layer 61a to the size and shape of before the start of the operation shown in FIGS. 7 and 8 of this time. Similarly, when the size and shape of the interior layer 71 can be maintained to the size and shape of before the start of the operation shown in FIGS. 7 and 8 of this time, the ejection controller 25a may maintain the size and shape of the interior layer 71 to the size and shape of before the start of the operation shown in FIGS. 7 and 8 of this time.

After the process of S153, the ejection controller 25a starts to shape the three-dimensional object 50 based on the manufacturing data and the sizes and shapes of the interior layer 61a and the interior layer 71 determined in S153 (S154).

The ejection controller 25a terminates the operation shown in FIGS. 7 and 8 after the process of S150, S152, or S154.

Next, the operation of the 3D printer 10 when determining the color ink for shaping the interior layer 61a and the interior layer 71 will be described.

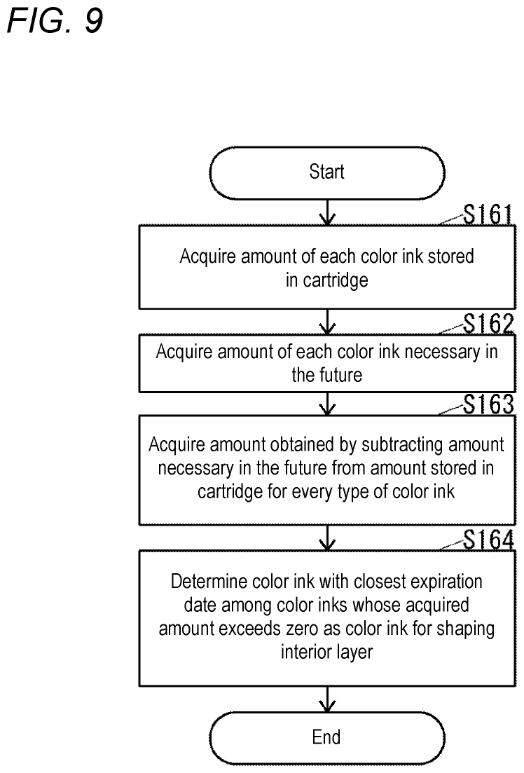

FIG. 9 is a flowchart of the operation of the 3D printer 10 when determining the color ink for shaping the interior layer 61a and the interior layer 71.

When starting the shaping of the three-dimensional object 50, the control unit 25 repeatedly executes the operation shown in FIG. 9.

As shown in FIG. 9, the ejection controller 25a acquires the amount of each color ink stored in the cartridge 16a through the cartridge reader 16 (S161).

Next, the ejection controller 25a acquires the amount of each color ink necessary in the future to realize the color of the outer appearance of the target shaped object 60 based on the manufacturing data (S162).

The ejection controller 25a then acquires, for each type of color ink, an amount obtained by subtracting the amount acquired in S162 from the amount acquired in S161 (S163).

Next, the ejection controller 25a determines the color ink with the closest expiration date acquired through the cartridge reader 16 of the color inks whose amount acquired in S163 exceeds zero as the color ink for shaping the interior layer 61a and the interior layer 71 (S164), and terminates the operation shown in FIG. 9. Therefore, when shaping the interior layer 61a and the interior layer 71, the ejection controller 25a uses the color ink of the type determined in S164.

In the operation shown in FIG. 9, the ejection controller 25a determines to fill the interior layer 61a and the interior layer 71 preferentially with the ink with the closest expiration date among the color inks. However, the ejection controller 25a may adopt a standard other than the expiration date as a standard for determining the color ink to be filled in the interior layer 61a and the interior layer 71. For example, the ejection controller 25a may keep control about the prices of the inks, and determine to fill the interior layer 61a and the interior layer 71 preferentially with the ink of low price among the color inks, or may determine to fill the interior layer 61a and the interior layer 71 preferentially with the ink whose amount acquired in S163 is large among the color inks. Furthermore, the ejection controller 25a may use a plurality of standards in a stepwise manner as a standard for determining the color ink to be filled in the interior layer 61a and the interior layer 71. For example, the ejection controller 25a may determine to fill the interior layer 61a and the interior layer 71 preferentially with the ink with the closest expiration date among the color inks, or may determine to fill the interior layer 61a and the interior layer 71 preferentially with the ink with low price among the color inks with the same expiration date. The ejection controller 25a may determine a method for determining the color ink to be filled in the interior layer 61a and the interior layer 71 in accordance with an instruction through the operation unit 21 or the communication unit 23.

As described above, the 3D printer 10 manufactures the three-dimensional object 50 by forming a part of the interior of the three-dimensional object 50 by replacing with an ink different from the originally scheduled ink so as to be the same as the outer appearance of the target shaped object 60 when the three-dimensional object 50 is manufactured by forming the entire three-dimensional object 50 with an originally scheduled ink, that is, an ink normally used based on the manufacturing data (S122 to S123 and S153 to S154), and thus can efficiently consume the ink while preventing the outer appearance of the target shaped object 60 from changing.

The 3D printer 10 forms the portion that does not affect the color of the color layer 62 when observed from the outer side of the target shaped object 60, that is, the interior layer 61a of the model layer 61 of the target shaped object 60 by replacing with a color ink different from the white ink and the clear ink scheduled originally, and thus can efficiently consume the color ink while preventing the color of the outer appearance of the target shaped object 60 from changing.

The 3D printer 10 fills at least one of the interior layer 61a of the target shaped object 60 and the interior layer 71 of the support portion 70 with the color ink while ensuring the amount of color ink necessary for realizing the color of the outer appearance of the target shaped object 60 (S122 to S123 and S153 to S154), and thus can enhance the possibility of appropriately realizing the color of the outer appearance of the target shaped object 60 even if the color ink is filled to at least one of the interior layer 61a of the target shaped object 60 and the interior layer 71 of the support portion 70.

The thickness of the color layer 62 of the target shaped object 60 is very thin. Therefore, the amount of color ink used to form the color layer 62 is extremely small as compared with the amount of white ink, clear ink, and support ink used when at least one of the interior layer 61a and the interior layer 71 is not provided in the three-dimensional object 50. Therefore, when at least one of the interior layer 61a and the interior layer 71 is not provided in the three-dimensional object 50, the possibility that at least a part of the color ink stored in the cartridge 16a will be discarded due to expiration is high. Since at least one of the interior layer 61a and the interior layer 71 is provided on the three-dimensional object 50, the possibility that the color ink will be discarded due to expiration can be reduced with the 3D printer 10.

When there exists an ink that is insufficient in amount if the interior of the three-dimensional object 50 is entirely formed with an originally scheduled ink, the 3D printer 10 forms a part of the interior of the three-dimensional object 50 not with an ink that is insufficient in amount if the interior of the three-dimensional object 50 is entirely formed with the originally scheduled ink but replacing the ink with an ink that remains if the entire three-dimensional object 50 is formed with the originally scheduled ink, and thus the possibility of discontinuing the manufacturing of the three-dimensional object 50 due to insufficiency of ink can be reduced.

To form at least one of the target shaped object 60 excluding the color layer 62 and the support portion 70 with only non-color ink, in a case where it is apparent before the start of shaping of the three-dimensional object 50 that the non-color ink is insufficient in amount (NO in S106, or NO in S114), when the insufficient amount exceeds the remaining amount obtained by excluding the amount of color ink necessary for realizing the color of the outer appearance of the target shaped object 60 from the amount of color ink held by the 3D printer 10 (NO in S110, or NO in S118), the 3D printer 10 does not start the shaping of the three-dimensional object 50 (S119), and thus can enhance the possibility of appropriately realizing the color of the outer appearance of the target shaped object 60 even if the color ink is filled to at least one of the interior layer 61a of the target shaped object 60 and the interior layer 71 of the support portion 70.

To form at least one of the target shaped object 60 excluding the color layer 62 and the support portion 70 with only non-color ink, the 3D printer 10 fills at least one of the interior layer 61a of the target shaped object 60 and the interior layer 71 of the support portion 70 with the color ink to (S153 to S154) when it becomes apparent that the amount of non-color ink will become insufficient during the shaping of the three-dimensional object 50 (NO in S136 or NO in S144), and thus can enhance the possibility of completing the three-dimensional object 50.

Since the 3D printer 10 fills at least one of the interior layer 61a of the target shaped object 60 and the interior layer 71 of the support portion 70 preferentially with an ink with close expiration date among a plurality of color inks (S164), the possibility of discarding ink due to expiration can be reduced. That is, since the 3D printer 10 forms a part of the interior of the three-dimensional object 50 by replacing with an ink whose expiration date is earlier than the originally scheduled ink, the possibility of discarding the ink due to the expiration can be reduced.

In the present embodiment, the 3D printer 10 forms the interior layer 61a of the target shaped object 60 and the interior layer 71 of the support portion 70 with color ink. However, the 3D printer 10 may form the interior layer 61a of the target shaped object 60 and the interior layer 71 of the support portion 70 with non-color ink. For example, the 3D printer 10 may form at least a part of the interior layer 61a of the target shaped object 60 with support ink while ensuring the amount of support ink necessary for realizing the support portion 70 when the expiration date of the support ink is the closest among the inks held by the 3D printer 10, may form at least a part of the interior layer 71 of the support portion 70 with white ink while ensuring the amount of white ink necessary for realizing the model layer 61 when the expiration date of the white ink is the closest among the inks held by the 3D printer 10, or may form at least a part of the interior layer 71 of the support portion 70 with clear ink while ensuring the amount of clear ink necessary for realizing the model layer 61 when the expiration date of the clear ink is the closest among the inks held by the 3D printer 10. Furthermore, the 3D printer 10 may not provide the interior layer 61a in the model layer 61 when the expiration date of the white ink and the clear ink is closer than the color ink and the support ink, or may not provide the interior layer 71 in the support portion 70 when the expiration date of the support ink is closer than the color ink, the white ink, and the clear ink.

Since the 3D printer 10 forms a part of the interior of the three-dimensional object 50 by replacing with an ink of lower price than the originally scheduled ink, the manufacturing cost of the three-dimensional object 50 can be reduced.

At least some of the various functions of the ejection controller 25a in each of the above-described embodiments may be realized by at least one computer outside the 3D printer 10.

What is claimed is:

1. A three-dimensional object manufacturing system for manufacturing a three-dimensional object with a plurality of inks, wherein
the three-dimensional object includes a target shaped object to be a target, and
the three-dimensional object manufacturing system manufactures the three-dimensional object by forming a part of an interior of the three-dimensional object by replacing with an ink different from an originally scheduled ink based on manufacturing data so as to be the same as an outer appearance of the target shaped object when the three-dimensional object is manufactured by forming the entire three-dimensional object with the originally scheduled ink based on the manufacturing data.

2. The three-dimensional object manufacturing system according to claim 1, wherein the plurality of inks include:
a coloring ink for forming a colored layer on a surface of the target shaped object; and
an inner ink filled to an inner layer on an inner side of the colored layer of the target shaped object, and
the three-dimensional object manufacturing system forms a portion that does not affect a color of the colored layer when observed from an outer side of the target shaped object in the inner layer by replacing with the coloring ink different from the originally scheduled inner ink based on the manufacturing data.

3. The three-dimensional object manufacturing system according to claim 1, wherein a part of the interior of the three-dimensional object is formed by replacing with the ink whose expiration date is earlier than the originally scheduled ink based on the manufacturing data.

4. The three-dimensional object manufacturing system according to claim 1, wherein a part of the interior of the three-dimensional object is formed by replacing with the ink that is lower in price than the originally scheduled ink based on the manufacturing data.

5. The three-dimensional object manufacturing system according to claim 1, wherein when the ink that is insufficient in amount when the entire interior of the three-dimensional object is formed with the originally scheduled ink based on the manufacturing data exists, a part of the interior of the three-dimensional object is formed not with the ink that becomes insufficient in amount when the interior of the three-dimensional object is entirely formed with the originally scheduled ink based on the manufacturing data but by replacing with an ink that remains when the entire three-dimensional object is formed with the originally scheduled ink based on the manufacturing data.

6. The three-dimensional object manufacturing system according to claim 1, wherein
the three-dimensional object includes a support portion for supporting the target shaped object at the time of shaping of the target shaped object as required,
the ink includes:
a coloring ink for forming a colored layer for realizing a color of the outer appearance of the target shaped object; and
a non-coloring ink that is not the coloring ink for forming at least one of the target shaped object excluding the colored layer and the support portion,
the three-dimensional object manufacturing system includes:
an inkjet head that ejects the ink; and
an ejection controller that controls ejection of the ink by the inkjet head, and
the ejection controller fills at least one of the interior of the target shaped object and the interior of the support portion that is not the colored layer preferentially with ink with closer expiration date among the plurality of coloring inks.

7. The three-dimensional object manufacturing system according to claim 6, wherein the ejection controller fills at least one of the interior of the target shaped object and the interior of the support portion that is not the colored layer with the coloring ink while ensuring a necessary coloring ink amount which is an amount of coloring ink necessary for forming the colored layer.

8. The three-dimensional object manufacturing system according to claim 7, wherein
when it is apparent before the start of the shaping of the three-dimensional object that the amount of non-coloring ink is insufficient to form at least one of the target shaped object excluding the colored layer and the support portion with only the non-coloring ink,
the ejection controller
starts the shaping of the three-dimensional object when the insufficient amount is less than or equal to a remaining amount obtained by removing the necessary coloring ink amount from the amount of the coloring ink held by the three-dimensional object manufacturing system, and
does not start the shaping of the three-dimensional object when the insufficient amount exceeds the remaining amount.

9. The three-dimensional object manufacturing system according to claim 6, wherein when it becomes apparent during the shaping of the three-dimensional object that the amount of non-coloring ink is insufficient to form at least one of the target shaped object excluding the colored layer and the support portion with only the non-coloring ink, the ejection controller fills at least one of the interior of the target shaped object and the interior of the support portion that is not the colored layer with the coloring ink.

10. A three-dimensional object manufacturing system for manufacturing a three-dimensional object with a plurality of inks, comprising:
a shaping table, and
a plurality of inkjet heads that eject the plurality of inks to form an ink layer on the shaping table, wherein
the three-dimensional object includes a target shaped object, and
the three-dimensional object manufacturing system forms a part of an interior of the target shaped object with an ink that is different from an ink that forms an exterior of the target shaped object.

11. A non-transitory computer-readable storage medium storing computer-executable three-dimensional object manufacturing program for manufacturing a three-dimensional object with a plurality of inks, the three-dimensional object comprising a target shaped object, when the program is executed by a processor, cause the processor to perform operations, the operations comprising: wherein
forming a part of an interior of the target shaped object with an ink that is different from an ink that forms an exterior of the target shaped object.
